(19) United States
(12) Patent Application Publication
(10) Pub. No.: US 2009/0177695 A1
(43) Pub. Date: Jul. 9, 2009

(54) INTEGRATION OF SOCIAL NETWORKING AND MERCHANDISING

(75) Inventors: Sameer S. Mahajan, Bellevue, WA (US); George Joy, Kirkland, WA (US); Jithendra K. Veeramachaneni, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/970,529

(22) Filed: Jan. 8, 2008

(51) Int. Cl. G06F 17/00

(52) U.S. Cl. 707/104.1; 707/E17.032

(57) ABSTRACT

Described is a technology by which a social networking service is integrated with merchandising data (e.g., a wish list and/or registry) corresponding to a person registered with a merchandising website. The social networking service maintains buddy lists, and social networking service application provides a mechanism to obtain the merchandising data for buddies that are registered with a merchandising website. The buddy list also may be used to provide a notification upon a change to the merchandising data, to facilitate collaboration among buddies in making a joint purchase, and/or to advertise a product or service to one or more entities (e.g., individuals or groups) associated with the buddy list, including the owner of the list. End users can customize who can see what merchandising data regarding themselves. End users can also interact with accessible merchandising data, e.g., click on a buddy's wish list link to buy from a corresponding shopping site.

### BACKGROUND

Many computer users interact with one another via social networking services (e.g., instant messenger, spaces using instant messenger and/or other social networking sites). Such sites maintain lists of buddies for their users, as well as buddies of buddies and so on for various contacts. These systems may also surface such information in various ways that are beneficial and useful to their users.

At the same time, there are online merchandising sites (e.g., shopping.msn.com) that cater to various customers' shopping needs for products and/or services. However, there is currently no interactive integration, that is customizable by end users, between social networking and shopping/advertising aspects of an online merchandising experience.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a social networking service is integrated with merchandising data corresponding to a person registered with a merchandising website. When the person is on a buddy list maintained by the social networking service, a client application program that accesses the social networking service obtains the buddy list and may obtain information corresponding to the merchandising data for each of the persons on the buddy list. The information may be used to couple a client device corresponding to the client application program to the merchandising data of the person. For example, a browser component running on the client device may render a merchandising data page corresponding to that person on the buddy list.

The buddy list also may be used to provide a notification upon a change to the merchandising data, to facilitate collaboration among buddies in making a joint purchase, and/or to advertise a product or service to one or more entities (e.g., individuals or groups) associated with the buddy list, including the owner of the list.

In one aspect, the shopping website maintains merchandising data for a person that is on a buddy list of a social networking service, and provides the social networking service with information by which the merchandising data may be accessed. For example, the information may couple the client device to the person's merchandising data webpage of a shopping website. In an alternative aspect, the information may (directly or indirectly) couple the client device to a database that maintains the merchandising data (and/or links thereto).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example aspects of integrating social networking with merchandising data of an example shopping site by way of a buddy list.

FIG. 2 is a block diagram representing example aspects of integrating social networking with an example shopping site by way of a buddy list and an intermediate database.

FIG. 3 is a flow diagram representing example steps taken to integrate a social networking application and service with a shopping site by way of a buddy list.

FIG. 4 is a representation of a user interface page by which a person can add and/or view profile information to a shopping website.

FIGS. 5 and 6 are representations of user interface pages by which a social networking service is used to obtain a person's merchandising data via a buddy list.

FIG. 7 shows an illustrative example of a computing environment into which various aspects of the present invention may be incorporated.

### DETAILED DESCRIPTION

Various aspects of the technology described herein are generally directed towards integrating social networking applications/services with a merchandising (i.e., shopping) website. While the various examples herein are generally directed towards coupling a social networking user to a buddy's wish list/registry corresponding to a shopping website, it is understood that these are only examples, and there are other aspects that are described herein, although not exemplified to the same extent. For example, a “buddy” can be a single user, or a group of users. As a further example, instead of a wish list, a user may be coupled to any other type of merchandising data, including a registry, product reviews, profile information and/or other merchandising-related information. Still further, a merchandising or shopping site is not limited to sites that provide actual products or services, but also includes sites such as auction sites and sites that locate products and services, such as those that search for products and services offered on other sites, e.g., by lowest price, by region, and so forth.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, social networking and merchandising/advertising in general.

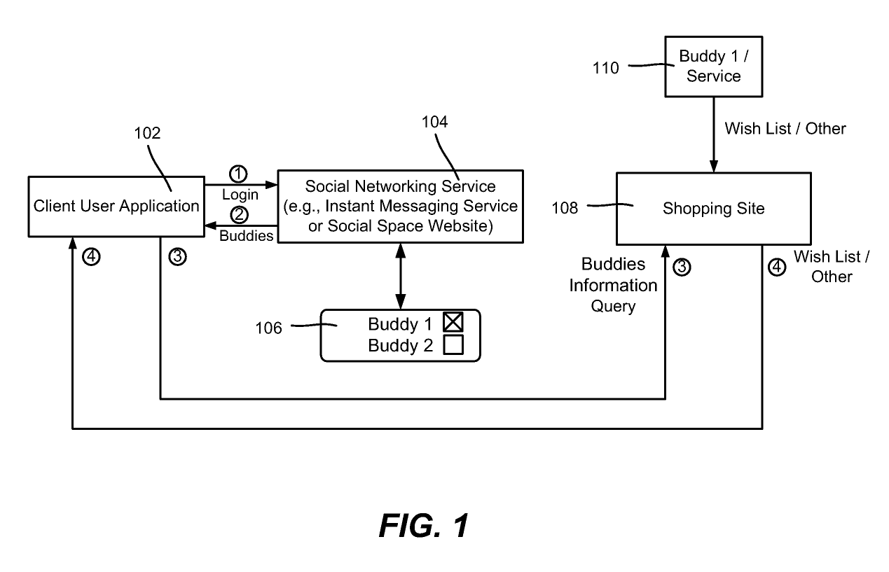

Turning to FIG. 1, there is shown an example networking environment in which a client user application 102 logs in to an instant messaging service and/or social networking service 104, as represented by the arrow labeled with circled numeral one (1). For purposes of brevity herein, the concept of social networking includes instant messaging, and thus “social networking” will be used herein except where otherwise noted. Further, although “application” is used to refer to the client program, it is understood that the client program may be a web browser, whether an actual application program or an operating system component.

As is known, a social networking service maintains a dynamic social network for individuals. A social networking service manages buddies and their relationships, along with their access privileges. Some social networking services may also manage dynamic groups (circles) of various contacts.

Thus, the social networking service 104 maintains information 106 about the client user and the user's buddies, including various privacy settings. In the example implementation of FIG. 1, in response to logging in, the user receives a buddy list or the like, as represented by the arrow labeled with circled numeral two (2). Note that the list may contain all buddies, the login (or further interaction) may specify a certain set of buddies, more than one set of buddy lists may be returned, and so forth.

As represented by the checked checkbox next to “Buddy 1” in the information 106, the social networking service 104 knows that Buddy 1 has a profile and merchandising-related data such as a wish list or other similar information (e.g., a registry) maintained on a shopping site 108. Note that privacy settings on the profile (e.g. wish list, shopping history, reviews and so forth) and/or items related to the profile can be made in relationship to the social network, such as visible only to a person's buddies, or some subset of buddies such as personal friends rather than coworker buddies.

In general, a shopping site provides a shopping experience, and typically involves items or services listed for sale and an ability to check out and buy such items or services. A shopping site may manage dynamic profiles, and shopping histories of various customers, as well as surface relationships between various items. A shopping site may also allow persons to upload registries (potentially multiple) of items or services that they would like to have.

Further, with explicit knowledge of an individual's social network, for privacy reasons a shopping site can allow specifying (such as at a per-registry or per-item level) a group of people (private, public, buddies, circles and the like) that have visibility to the items or services desired. A shopping site may also provide targeted advertising and notifications, which may be based on a user opting in to receive such data.

Note that in the example, of FIG. 1, Buddy 1 and/or a service (block 110) acting on behalf of Buddy 1 has provided such information to the shopping site 108 at some previous time. By way of example, a person (Buddy 1) can log onto the shopping site 108, create a profile, and/or add desired products and services to his or her wish list. As another example, a service can automatically add a new album or book to a person's wish list, such as if the person registered a certain artist or author with the service and new content is released.

Whether automatically or in response to some client action, a query or the like requesting information on Buddy 1 (and possibly other buddies) is sent to the shopping site 108, as represented by the arrow labeled with circled numeral three (3). For example, the social networking site 104 may provide a tag or URL to Buddy 1's wish list page automatically or if the client indicates a desire to view it. In response, the client user application receives a wish list (or other merchandising data) page, as represented by the arrow labeled with circled numeral four (4). APIs may also be exposed by each entity, which may be used in conjunction with tags, URLs or the like.

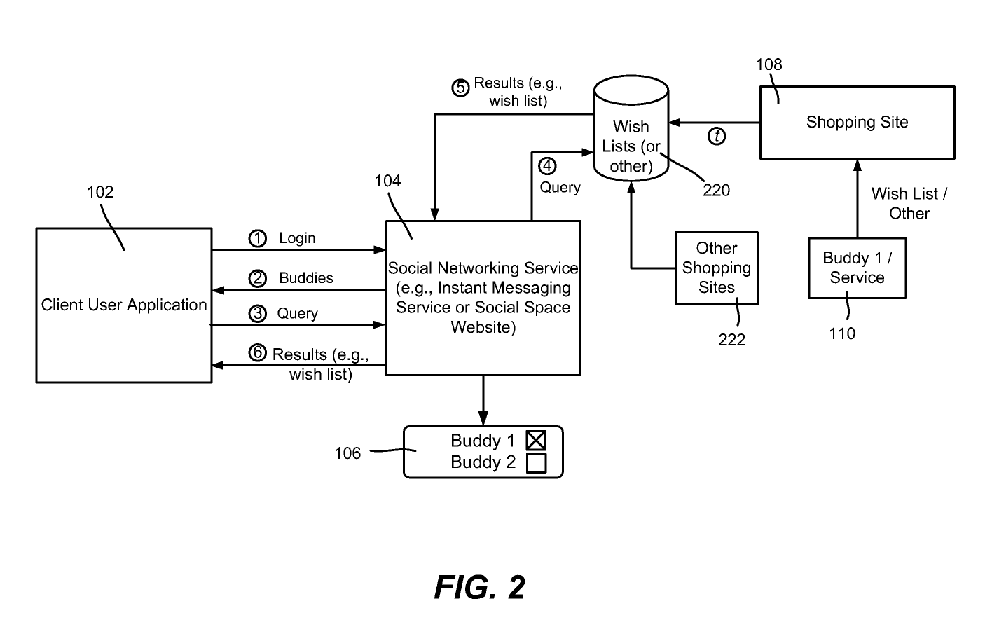

Turning to FIG. 2, an example similar to that of FIG. 1 is shown, except that rather than coupling the client user application 102 to the shopping site 108, the social networking service 104 couples the user to a database 220 which has previously, at some time represented by the circled letter t, provided the shopping information to the database 220. The information may also be provided by other shopping sites 222. The database 220 may be updated periodically or in some other manner by the shopping site or sites (108, 222).

In this manner, after login and receiving the buddies list (the arrows labeled one (1) and two (2), respectively), a user query is made via the social networking site 104 (the arrow labeled three (3)). The social networking site 104 queries the database 220, which then retrieves the requested information and provides the results back to the client user application, as represented in FIG. 2 by the arrows labeled four (4) through six (6), respectively. As a result, the client user application does not have to directly visit the shopping site 108, and can instead interact with the social networking service 104. Note that this makes it easy for the social networking service 104 to count clicks and/or track purchases which may be used to generate revenue. Further note that it is feasible for the client user application to send a query directly to a database service and receive the results, rather than through the social networking service 104.

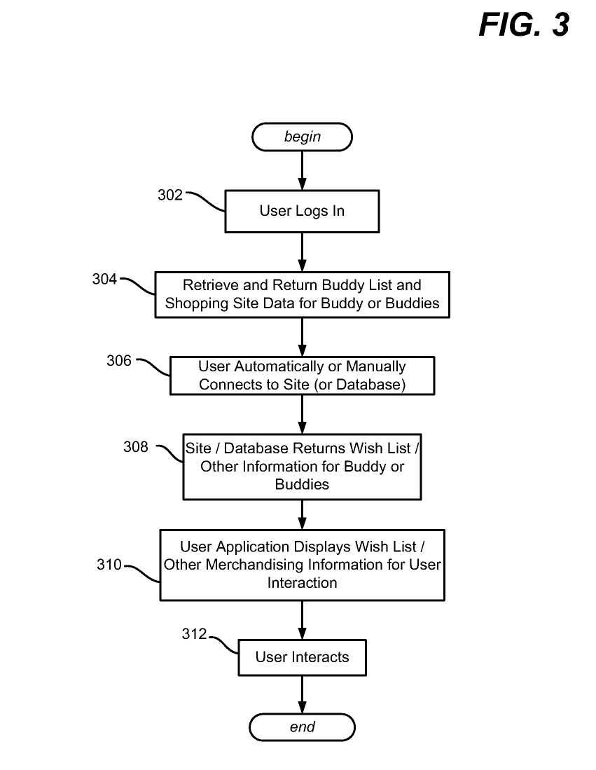

FIG. 3 summarizes the various steps taken to integrate a social networking service with a shopping website or corresponding database, beginning at step 302 where the user logs into the social networking service. Step 304 represents retrieving and returning the buddy list to that user after appropriate login interaction, e.g., including credentials evaluation. This includes providing the client user with a mechanism for connecting to the shopping site or (directly or indirectly) to a database containing shopping information for each buddy that is appropriately registered as having such information.

At step 306, the user uses the mechanism (e.g., automatic redirection to a URL, or in response to a manual user action) to connect to the shopping site or database. In response, the user receives merchandising data such as in the form of a wish list page or other shopping-related information for that buddy (step 308). At step 310, the corresponding page or the like is displayed to the user, with which the user can interact to make a purchase, for example.

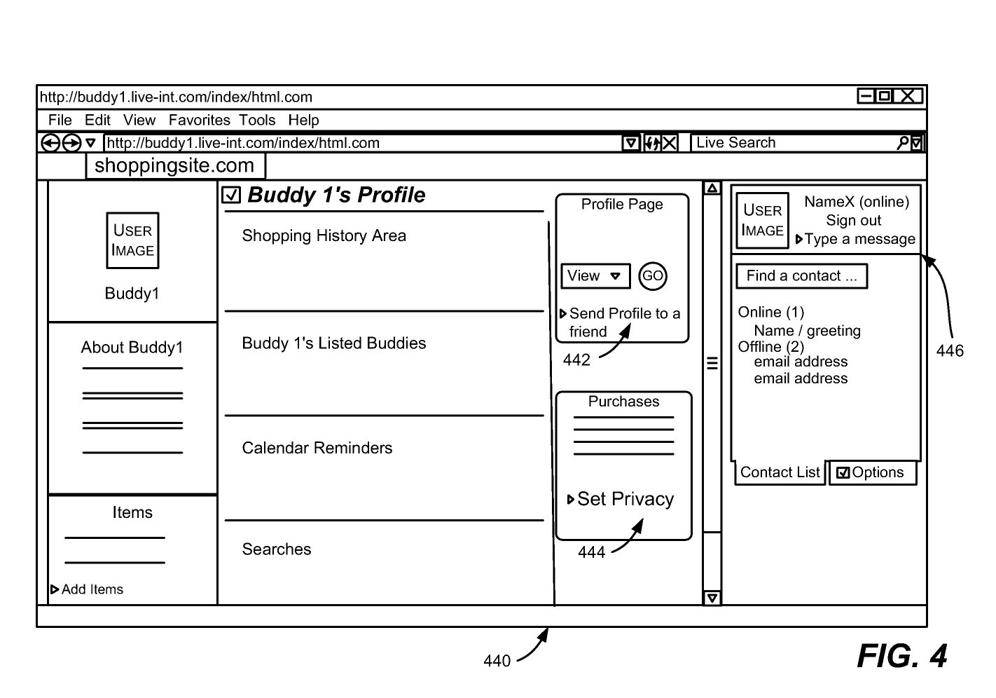

Some example scenarios that that relate to the integration of a social networking service/application with a shopping website based on buddy information are described with reference to the examples of FIGS. 4-6, which generally show example user interfaces to programs on a display screen.

FIG. 4 shows an example user interface page 440 comprising a profile page for Buddy 1. Among other data entry options, Buddy 1 can interact with the page to control who can receive this profile, via link 442. Buddy 1 is also able to set privacy (e.g., privacy levels) via link 444 with respect to which other users can see what information. Note that Buddy 1 can switch to interact with other users via a social networking service, in this example comprising an instant messenger application program 446.

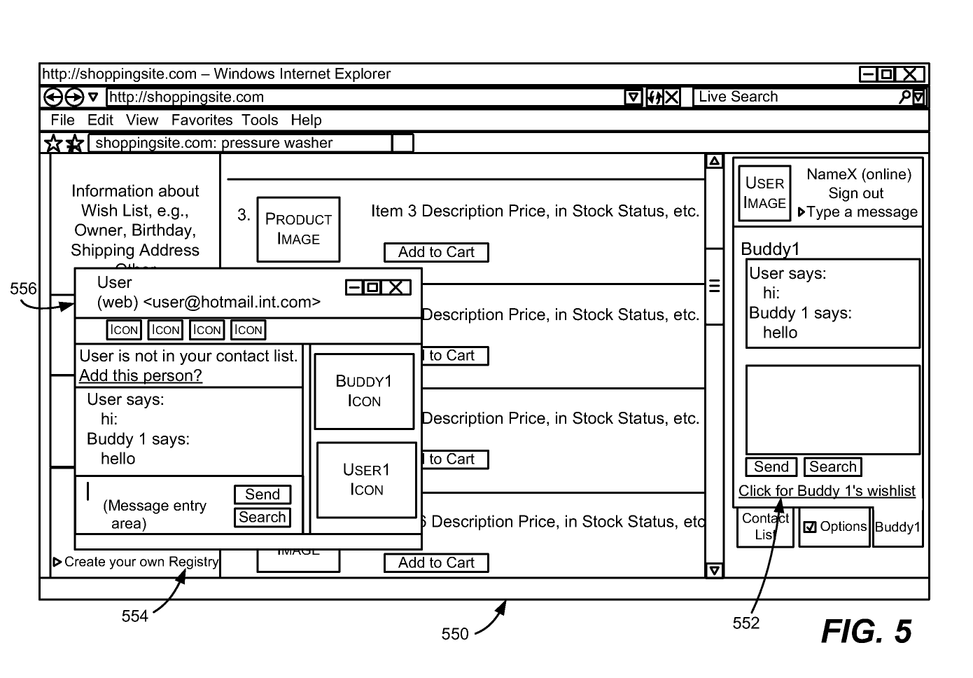

FIG. 5 shows an example user interface display including a conversation Buddy 1 is having with another user, which facilitates interaction with Buddy 1's wish list page 550. For example, via the link 552, the user has previously requested to view Buddy's wish list 550, whereby as shown in the current state of FIG. 5, the user can switch back and forth between programs as desired. The user can also create his or her own registry via the link 554. Note that in this example, a conversation user interface 556, which is also related to the messenger conversation, overlays the wish list page 550 and its corresponding browser program.

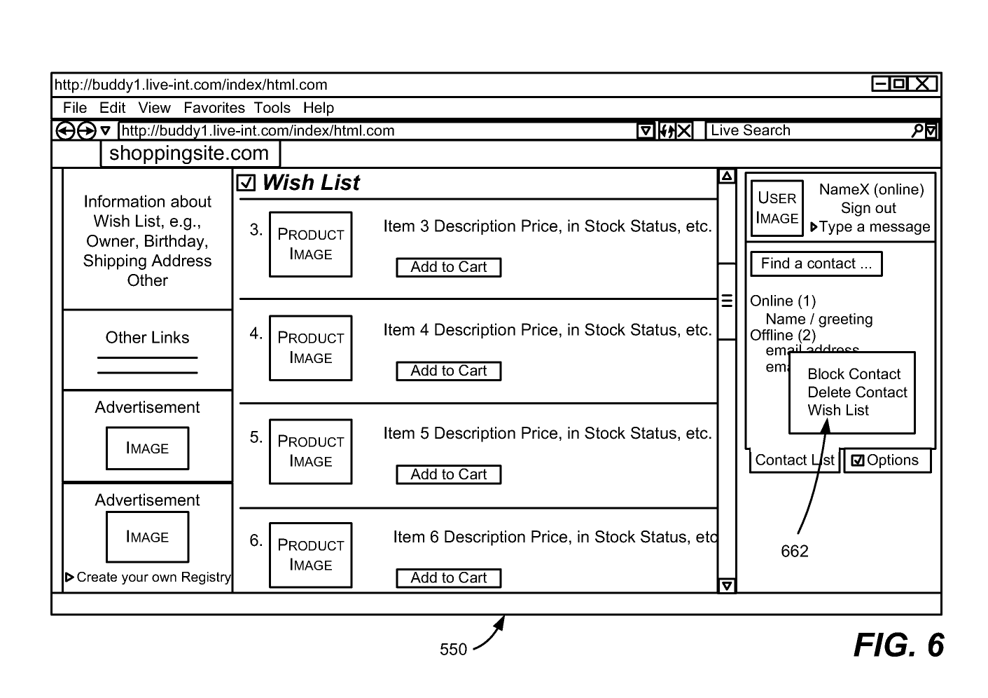

FIG. 6 shows an alternative way to view the wish list page 550 of Buddy 1 via a link 662. In this example, the link 662 pops up in a menu in a messenger program window, and can switch among different contacts to view each of their merchandising data pages (for each contact that has any). As can be readily appreciated, given the example implementations of FIGS. 1-3, numerous mechanisms to integrate a social networking service with a shopping website are feasible.

For example, with such wish list/registry information visible, the client user may interact (e.g., hover over Buddy 1's representative icon in a social networking application program window) and notice that Buddy 1 is interested in a certain Audio CD. Clicking on this item takes the user to the shopping site, where he or she checks it out to present it to Buddy 1. This action also removes the item CD from Buddy 1's registry/wish list so that no other friend buys the same item.

As another example, alerts of updates made to a person's merchandising data (e.g., registry/wish list) may be sent to a person's buddies, including online alerts and/or offline alerts, e.g., by email/text and the like. A buddy may then decide to purchase something recently added, for example. Still further, a user may notice that his or her buddies are particularly interested in an item, such as a new popular video game. The user may decide to order the game or add it to his wish list.

Collaboration is another example use of the technology described herein. For example, if a user notices that other buddies are interested in a product that can be shared because it is not often needed, such as a pressure washer, the various buddies may collaborate and together buy one item for sharing.

Further, such merchandising data in conjunction with buddy lists may facilitate targeted advertising, e.g., a person that is interested in an item by adding it to a shopping registry/wish list may have buddies that are similarly interested in such a product, as buddies are often of the same mindset, e.g., all are video game enthusiasts. Thus, it may be profitable to target advertising to the buddies that is directed to same or similar items. A social networking service may also obtain advertising revenue in this process as a result of driving traffic to the shopping site based on the number of clicks or actual purchases. For example, each item may be associated with a URL to facilitate tracking that the purchase came from a social networking-provided wish list rather than in some other manner.

As can be seen, the integration is highly flexible and extensible via the framework that allows the integration and enables new scenarios. As described above, the social network (e.g. buddy list) information may be surfaced in the context of shopping site, and/or shopping profiles can be surfaced within the context of a social network (e.g. buddies). Advertising and notifications may be performed, including in a manner that is acceptable to users, such as by making use of each user's settings to generate only the right amount of traffic for that user.

### Exemplary Operating Environment

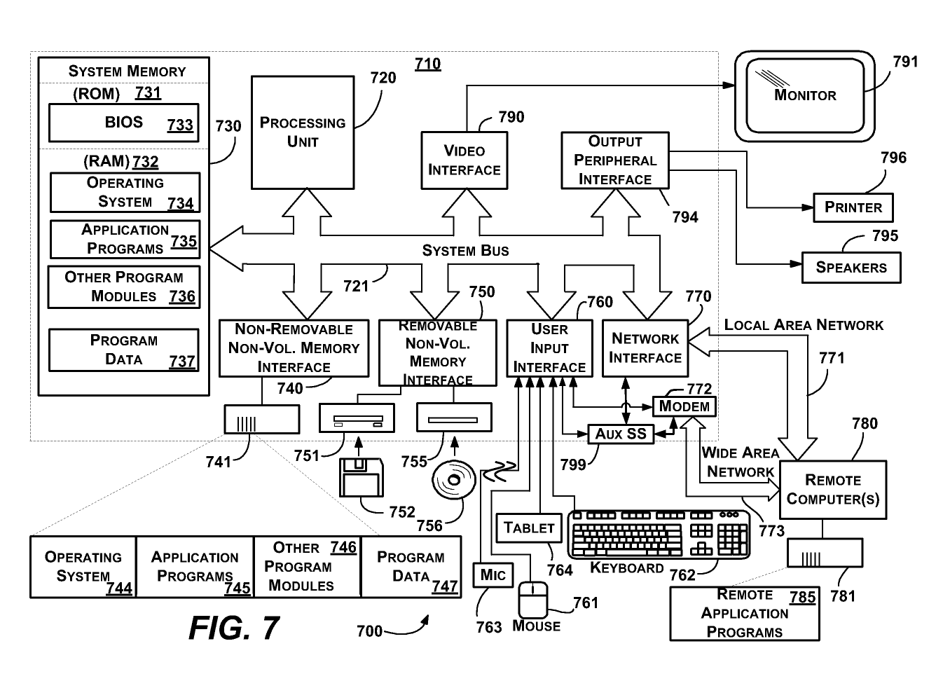

FIG. 7 illustrates an example of a suitable computing system environment 400 on which the examples of FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, integrating a social networking service with merchandising data corresponding to a person registered with a merchandising website, in which the person is on a buddy list maintained by the social networking service, including by obtaining a buddy list at a client application program that accesses the social networking service, obtaining information corresponding to the merchandising data for the person, and coupling a client device corresponding to the client application program to the merchandising data of the person.

2. The method of claim 1 wherein obtaining the information corresponding to the merchandising data comprises receiving a URL that corresponds to at least part of the merchandising data for accessing by a web browser of the client device.

3. The method of claim 1 wherein obtaining the information corresponding to the merchandising data comprises accessing a database that provides the merchandising data.

4. The method of claim 3 further comprising, updating the merchandising data in the database from a shopping website.

5. The method of claim 1 further comprising, using the buddy list to provide a notification to a client corresponding to the client device upon a change to the merchandising data.

6. The method of claim 1 further comprising, using the buddy list of a client corresponding to the client device and the merchandising data to collaborate with at least one person on the buddy list in making a purchase.

7. The method of claim 1 further comprising, using the buddy list of a client corresponding to the client device and the merchandising data of the person to advertise a product or service to at least one other entity associated with the buddy list.

8. In a computing environment, a system comprising, a social networking service that integrates a client application program running on a client device with merchandising data corresponding to a person registered with a merchandising website, in which the person is on a client buddy list maintained by the social networking service, including by coupling the client device to the merchandising data of the person via information on the buddy list.

9. The system of claim 8 wherein the social networking service corresponds to a messenger service and wherein the client application program comprises a messenger program.

10. The system of claim 9 wherein the messenger program includes a mechanism for retrieving the merchandising data for the person.

11. The system of claim 8 wherein the social networking service corresponds to a website and wherein the client application program comprises a web browser.

12. The system of claim 8 wherein coupling the client device to the merchandising data comprises receiving a URL that corresponds to at least part of the merchandising data.

13. The system of claim 8 further comprising a database that maintains information corresponding to the merchandising data.

14. The system of claim 8 wherein the merchandising data is maintained on a shopping website in association with profile data for the person.

15. A computer-readable medium having computer-executable instructions, which when executed perform steps, comprising:
maintaining merchandising data for a person that is on a buddy list of a social networking service; and
providing the social networking service with information by which the merchandising data may be accessed.

16. The computer-readable medium of claim 15 wherein providing the social networking service with the information comprises providing at least one URL to the social networking service.

17. The computer-readable medium of claim 15 wherein providing the social networking service with the information comprises providing the information for storing in a database coupled to the social networking service.

18. The computer-readable medium of claim 15 having further computer-executable instructions, comprising, detecting a change to the merchandising data, and using the buddy list to notify at least one entity on the buddy list that the change has been detected.

19. The computer-readable medium of claim 15 having further computer-executable instructions, comprising, using the buddy list to allow at least two entities on the buddy list to collaborate in making a purchase.

20. The computer-readable medium of claim 15 having further computer-executable instructions, comprising using the buddy list and the merchandising data to advertise a product or service to at least one entity associated with the buddy list.
